(19) United States
(12) Patent Application Publication
(10) Pub. No.: US 2024/0112528 A1
(43) Pub. Date: Apr. 4, 2024

(54) GENERATING RANDOM GAME OUTCOMES DURING REEL SPINS

(71) Applicant: Aristocrat Technologies, Inc., Las Vegas, NV (US)

(72) Inventors: Matthew Belger, Las Vegas, NV (US); Scott Delekta, Las Vegas, NV (US)

(21) Appl. No.: 18/224,855

(22) Filed: Jul. 21, 2023

Related U.S. Application Data
(60) Provisional application No. 63/412,089, filed on Sep. 30, 2022.

(51) Int. Cl. G07F 17/32

(52) U.S. Cl. CPC G07F 17/3213; G07F 17/3262

(57) ABSTRACT

In contrast to conventional slot technology, embodiments of gaming devices described herein generate and/or modify a game outcome, or part of a game outcome, based on symbols that spin by while the one or more reels are spinning (herein referenced within this disclosure as “winning-while-spinning game operation”). Various embodiments of gaming devices described herein include new and/or improved gaming process control functions to implement the winning-while-spinning game operation while complying with gaming regulations. This may include using random number generator calls to dynamically generate reel strips, determining the number of revolutions and/or partial revolutions to spin reel strips, determining the number of steps to move the stepper or the time or frequency the reels step, and so on.

### CROSS-REFERENCE TO RELATED APPLICATION

This application is a nonprovisional and claims the benefit under 35 U.S.C. 119(e) of U.S. Provisional Patent Application No. 63/412,089, filed Sep. 30, 2022, the contents of which are incorporated herein by reference as if fully disclosed herein.

### BACKGROUND

Electronic gaming machines (“EGMs”) or gaming devices provide a variety of wagering games such as slot games, video poker games, video blackjack games, roulette games, video bingo games, keno games, and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens, or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table,” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

In a typical “slot” type game, as described above, a game outcome is determined based on which symbols are displayed in a row-by-column grid or matrix. The row-by-column grid or matrix may be formed using a number of spinning reels. As the reels stop spinning, the row-by-column grid or matrix may be formed in which various symbols are displayed. A game outcome is determined based on the symbols that are displayed in the row-by-column grid or matrix. However, determining a game output based on which symbols are displayed on each reel while the reels are spinning has substantial design problems to comply with various gaming regulations.

### SUMMARY

One embodiment described herein takes the form of a system that includes a non-transitory storage medium that stores instructions and a processor. The processor executes the instructions to, for a game instance that includes reels, generate a dynamic reel strip using a random number generator call, the dynamic reel strip assigned to one of the reels and including special symbols; during spinning of the reels, track an amount of the special symbols that spin by on the one of the reels; once the amount of the special symbols reaches a designated number, stop the spinning of the reels; and generate a game outcome.

A second embodiment described herein takes the form of a system that includes a non-transitory storage medium that stores instructions and a processor. The processor executes the instructions to, for a game instance that includes reels, use a random number generator call to determine a number of at least partial revolutions to spin a reel strip assigned to one of the reels; during spinning of the reels, track an amount of special symbols that spin by on the one of the reels; once the amount of the special symbols reaches a designated number, stop the spinning of the reels; and generate a game outcome.

Still another embodiment described herein takes the form of a system that includes a non-transitory storage medium that stores instructions and a processor. The processor executes the instructions to, for a game instance that includes reels, use a random number generator call to determine a number of steps to move a stepper corresponding to one of the reels or a time or frequency that the one of the reels steps, the one of the reels including special symbols; during spinning of the reels, track an amount of special symbols that spin by on the one of the reels; once the amount of the special symbols reaches a designated number, stop the spinning of the reels; and generate a game outcome.

Various configurations are possible and contemplated without departing from the scope of the present disclosure.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in a block diagram form, an implementation of a game processing architecture algorithm that implements a game processing pipeline for the play of a game in accordance with various implementations described herein.

FIG. 4 depicts a flow chart illustrating an example method for operating dynamic reels of a game. The method may be performed by one or more of the devices depicted in FIGS. 1-3.

FIG. 5A depicts a first example screen view of a game described using FIG. 4.

FIG. 5B depicts a second example screen view of a game described using FIG. 4.

FIG. 5C depicts a third example screen view of a game described using FIG. 4.

FIG. 5D depicts a fourth example screen view of a game described using FIG. 4.

FIG. 6 depicts a flow chart illustrating an example method for operating dynamic reels and a wheel of a game. The method may be performed by one or more of the devices depicted in FIGS. 1-3.

FIG. 7A depicts a first example screen view of a game described using FIG. 6.

FIG. 7B depicts a second example screen view of a game described using FIG. 6.

### DESCRIPTION

In a slot type game, a player may push a button, pull a lever, touch a touch-sensitive display, or otherwise interact with a game device to cause one or more reels to spin. The reel may be a strip having symbols on it. Some game devices use mechanical reels while others use electronic (or simulated) reels (e.g., video reels). If the slot type game is an electronic game, the simulated reel may be displayed and animated (for example, to simulate spinning) on a display of the slot type game. If the slot type game is a mechanical game, then one or more reels may be caused to spin by a stepper motor. In both the electronic and the mechanical slot games, as the one or more reels stop spinning, an award value to the player may be determined based on various symbols of the reels being displayed on a playing field. In other words, after determining the reels stop, the slot type game can then evaluate and determine the payout according to the symbols that have landed on the reels.

In contrast to conventional slot technology, embodiments of gaming devices described herein generate and/or modify a game outcome, or part of a game outcome, based on symbols that spin by while the one or more reels are spinning (herein referenced within this disclosure as “winning-while-spinning game operation”). As a result, the gaming device can no longer wait and determine a game outcome by evaluating the symbols that land after the reels stop spinning. Such random game modifications when one or more reels are in the reel spin state, thus, present new game design challenges relating to controlling the degree of randomness at a target level within random gaming environment. Managing the degree of randomness becomes a compounding problem when the game device incorporates other game mechanics, such as landing re-spin symbols. Thus, the game device needs to include new and/or improved gaming process control functions to implement the winning-while-spinning game operation while complying with gaming regulations.

Various embodiments of a gaming device can implement one or more gaming process control functions to generate and/or modify the game outcome according to the winning-while-spinning game operation. In one embodiment, the gaming device implements a process control function that randomly determines the number of special symbols that will spin by for a given reel. If multiple reels will implement the winning-while-spinning game operation, the gaming device may perform separate RNG calls to determine the number of special symbols that will spin by for each reel. To create a relatively higher degree of randomness, the gaming device generates a dynamic reel strip that randomly determines the number of special symbols, reel positions for the special symbols, and/or reel length. By utilizing a dynamic reel strip, the reel strip layout will vary from game instance to game instance to avoid being predictive. During a given game instance, when the designated reels are spinning and special symbols spin by, the gaming device tracks and/or counts the accumulation of the special symbol type. For a given reel, once the number of special symbols that spin by reaches the designated number of special numbers, the reel stops.

In one or more embodiments, rather than directly determining the number of special symbols the game outcome will award, the gaming device implements a gaming process control function that randomly determines the number of revolutions and/or partial revolutions to spin the entire length of a given reel strip. As an example, if the gaming device determines the number of revolutions to be two for a given reel, the reel will spin through its entire reel strip twice. The gaming device tracks and counts the number of special symbols that spin by during the two different revolutions. The number of revolutions the gaming device randomly determines may be weighted and controlled based on the number of special symbols in the given reel strip. The given reel strip can be predetermined or known, or can be a dynamic reel strip.

In one or more embodiments, for a game that utilizes mechanical reels or a secondary reel, the game determines the number of steps to move the stepper or the time or frequency the reels step. For mechanical reels, symbols cannot be randomly generated. Thus, the special symbols are in specific reel positions and cannot be changed. By randomly determining the number of reel steps and/or time the reels step, the game can track and monitor the number of special symbols that spin by.

In various embodiments, each reel is formed from a set of symbols; these symbols may be standard symbols or special symbols as explained below. Generally, with respect to some embodiments described herein, standard symbols award a prize (e.g., a payout, bonus spins, prize increments, bonus games, additional multipliers, and so on) when a sufficient number of standard symbols appear across a playing field, in a certain sequence, combination, or the like. Special symbols may (or may not) likewise award a prize or payout but may trigger an initiation or operation of a special mode. Special symbols may trigger a special mode such as a bonus game, increase a payout or provide another award while the special mode is active. The payout during the special mode is increased each time a special symbol appears on a portion of a spinning reel displayed in a playing field. Special symbols may appear more than once as the reel spins, and the payout or prize may increment each time the special symbol(s) appears. As the reel stops spinning, and the special mode ends, a final payout is calculated and awarded to the player.

Special symbols may be of two different types—a target symbol and a trigger symbol. Each target symbol is associated with a certain award value, for example, a credit value. A trigger symbol causes the game to begin or enter into the special mode when the trigger symbol is displayed along with at least one target symbol. During the special mode, one or more reels are spun, and a number of times a trigger symbol is displayed on each spinning reel is tracked. Each occurrence of a trigger symbol on the spinning reel updates an award value to the player that corresponds to a target symbol. If a trigger symbol is displayed when the reel stops spinning, the special mode of the game repeats.

Various embodiments of the present disclosure are directed to an improved gaming device and methods of operating the improved gaming device. In contrast to conventional slot technology, an improved gaming device, as described herein, may generate a game outcome based on symbols that are displayed on one or more reels while the one or more reels are spinning. Each reel is formed from a set of symbols; these symbols may be standard symbols or special symbols. Generally, standard symbols are graphical or alphanumeric characters that may award a prize (e.g., a payout) when a sufficient number of them appear across a playing field, in a certain sequence, combination, or the like. Special symbols may (or may not) likewise award a prize or payout but are also tied to the initiation or operation of a special mode. Special symbols may, for example, trigger a special mode such as a bonus game, may increase a payout or provide another award while the special mode is operative, or the like.

Generally, the special mode of the gaming device is an operational mode in which a player may be awarded a prize or payout while one or more reels are spinning instead of only when all reels stop spinning. It should be appreciated that the prize or payout is accrued from the appearance of a symbol on a spinning reel rather than a stationary reel.

In some embodiments of the gaming device, as described herein, if one or more special symbols are displayed on the one or more reels then the player may be awarded an additional chance to increase the award value via a bonus game or special game (collectively, a “special mode”). There are two types of special symbols—a target symbol and a trigger symbol. Each target symbol may be associated with a certain award value, for example, a credit value. A trigger symbol may cause the game to begin or enter into the special mode. As an example, the trigger symbol triggers a special mode that causes one or more reels in the playing field to start spinning and accumulate additional trigger symbols while the reels are spinning. Accumulation of trigger symbols during the special mode causes a targeted award value associated with a target symbol to increase or update. Thus, no specific award value may be associated with the trigger symbol, but a number of times the trigger symbol is displayed during the special mode causes the targeted award value of the target symbol to be updated (or increased).

If the symbols displayed on the one or more reels include both the target symbol and the trigger symbol when the reels stop spinning, then the game may begin or enter into the special mode. In other words, if only trigger symbols or only target symbols are displayed when the reels stop spinning, then the special mode is not entered. It should be appreciated that the trigger symbol(s) and target symbol(s) need not appear on the same reel to initiate the special mode.

Generally, certain embodiments show each reel in a separate column on a display. Each reel shows the same number of symbols in certain embodiments, such that adjacent symbols on different reels are organized into rows. The number of rows and columns may vary between embodiments. This row and column arrangement is referred to herein as a “playing field.” In certain embodiments, one reel may be separated from the others on the playing field. This separated reel is referred to as a “trigger reel” and discussed in more detail below. While this disclosure discusses the use of a single trigger reel on a playing field, embodiments may utilize multiple trigger reels, may not separate the trigger reel from other reels on the playing field, may position the trigger reel at any location on the playing field, may highlight or otherwise differentiate a trigger reel, may utilize a trigger reel(s) that appears identical to other reels, may utilize a trigger reel(s) that only appears under certain circumstances, may have a playing field with more or fewer rows in certain columns (and thus display more or fewer symbols per game or mode for certain rows), and so on.

In the special mode, a reel on which the trigger symbol is displayed is spun again while other reels may be held steady. The reel on which the trigger symbol is displayed may be referred to as a “trigger reel” in the present disclosure. While the trigger reel is spun again, a number of times a trigger symbol appears on the spinning reel is displayed as part the game (for example, by a meter, counter, or the like). Typically, the trigger symbols are animated or otherwise shown on the reel or moving along the reel in such a fashion that a user can register their presence. That is, the symbol may appear to “float” or “slide” along, or be decoupled from the reel and maintained on the playing field even while the reel continues to display a spinning animation; this spinning animation is typically too fast for a player to make out individual symbols. Thus, the player can visually and/or audibly register the presence of the trigger symbol during the special mode. When the trigger reel stops spinning, an award value is incremented (or awarded to a player) based on a number of times the trigger symbol was displayed on or “above” the spinning reel. In this manner, the player may accrue credits, prizes, or the like while one or more reels are spinning instead of solely when all reels stop or are stationary.

If a trigger symbol is displayed on the trigger reel when it stops spinning, then the gaming device may re-initiate the special mode. This may continue until no trigger symbol is displayed on the trigger reel when the trigger reel stops spinning.

In some embodiments, a gaming device may generate a game outcome based on special symbols displayed on one or more reels while the reels are spinning. A set of symbols to be displayed on each reel while the reels are spinning may be randomly and/or dynamically determined. As described herein, the symbols may take the form of a letter, a number, an image, a series of letters, a series or combination of the foregoing, and so on. Symbols may be further categorized as standard symbols, prize symbols, target symbols, and/or trigger symbols.

In some implementations, standard symbols may yield a win to a player when the symbols are in a certain position, or form a particular pattern or alignment, on a playing field. Prize symbols may award a cash or credit win to the player when they appear on a playing field, regardless of the presence or absence of other symbols. Target symbols may have a corresponding multiplier or a cash/credit value assigned to them and so may increase an amount of a payout accordingly. Trigger symbols may initiate (“trigger”) the special mode of the game.

When one or more target symbols are displayed on one or more reels when the reel(s) stop but no trigger symbol is displayed on any reel, the game device does not initiate the special mode. Rather, the game ends. By contrast, if both a target symbol and trigger symbol are displayed in the playing field when all reels stop, the special mode is started. It should be appreciated that the target symbol and trigger symbol need not be displayed on the same reel. Additionally, it should be appreciated that only the reel(s) displaying a trigger symbol will re-spin as part of the special mode.

As previously mentioned, certain examples of a gaming device may use electronic reels. These electronic reels may be constructed from various symbols either in advance of a game or during a game instance or a round play. In either event, after a set of symbols for a reel is randomly selected using a random number generator, a respective order and a corresponding position on the reel for each such symbol may be randomly and/or dynamically determined using a random number generator. As a result, the symbols on each reel are typically random or semi-random, presuming the reel is not preconfigured.

Alternatively, one or more reels may be randomly selected from a plurality of reels, and each reel of the plurality of reels may be preconstructed from symbols. The plurality of reels may be virtual and stored in a system memory of an electronic gaming device.

Further, as the game enters into the bonus game mode or the special mode, a set of symbols for the trigger reel may be dynamically and/or randomly updated (or a different reel may be selected from a plurality or pool of reels). During the special mode, a duration for which the trigger reel is spun may be randomly determined using a RNG. Alternatively, or additionally, a reel length and/or a reel speed may also be randomly determined for each reel spinning during the special mode. In some implementations, a spinning speed of the trigger reel in the special mode may be set to be different from its speed during other game modes.

In some cases, a duration, a reel length, and/or a reel speed of the trigger reel during the special mode may be determined based on any or all of: the one or more particular target symbols displayed during a previous spin; a number of times the one or more particular target symbols displayed during the previous spin; and/or a particular trigger symbol displayed during the previous spin.

During the special mode, while the trigger reel is spinning, with each occurrence of the trigger symbol being displayed, the cash or credit amount and/or a multiplier corresponding to the target symbol displayed on one or more reels may be updated. As described herein, during the special mode, only the trigger reel (or reels) is spun, and other reels are held steady.

In another embodiment, a gaming device may include a virtual or physical wheel in addition to a plurality of reels described above. In such embodiments, trigger symbols displayed during a special mode may affect a value, content, or other aspect of the wheel instead of a payout associated with the reels or the playing field. As yet another option the special mode may be implemented on or executed by the wheel instead of a reel of the gaming device. Further, the special mode may still be initiated through operation of the reels—for example, by having both a trigger symbol and target symbol displayed on the playing field when the reels stop spinning—but the special mode may be executed by the wheel. Thus, it can be seen that initiation of a special mode may be performed by a first component of a gaming device while execution of the special mode may be performed by a second component of the gaming device.

During the special mode, one or more reels of the plurality of reels are randomly chosen to spin, although in some embodiments the same reel or reels may spin every time in the special mode. As the one or more reels are spinning, the credit value to the user may be increased and/or updated based on one or more special symbols displayed on the one or more spinning reels, and/or a number of times the one or more special symbols are displayed on the one or more spinning reels.

Further, various embodiments as described herein, for generating a set of symbols for each reel being spun during the special mode, determining a respective order and corresponding position of each symbol in the set of symbols for each reel being spun during the special mode, determining a duration for which each reel is spun during the special mode, and/or determining a reel length and/or a reel speed of each reel to spin during the special mode may also apply for the gaming device including the spinning wheel and the plurality of reels.

Additionally, while a duration, a reel length, and/or a speed of a reel used in the special mode may be randomly determined, in some implementations any or all of these parameters may be determined based on the credit value landed on the wheel when the wheel stops spinning.

In yet another embodiment of a gaming device, the gaming device may include a plurality of reels, as described above. A user may cause the plurality of reels to spin. While the plurality of reels are spinning, the reels are monitored for a number of times one or more special symbols are displayed on one or more spinning reels. If the number of times the one or more special symbols are displayed on the one or more reels meets a particular criterion, then the game may enter into the special mode, as described above. In some implementations, the special mode may be referenced as entering a hold and spin feature. During the hold and spin feature, the game designates one or more reels to spin. While the one or more designated reels are spinning, each time a special symbol appears on any of the one or more designated reels, a credit value associated with the special symbols that triggered the hold and spin feature are upgraded or updated.

Embodiments may vary any of the foregoing. As one example, the randomly selected reel length may be within a predetermined range of reel lengths. In some implementations, the predetermined range of a reel length may be selected based on a number of tickets, tokens, credits, and/or cash input from the player to begin the game.

In some embodiments, the target symbol (or the special symbol) as described herein, may correspond to, or provide to a player upon a win, any or all of a credit and/or a wild multiplier, an additional spin, a free game, an increase in a reel length, an increase in duration of a reel spin, more symbols per reel or a reel length unit, an increase in a number of rows and/or columns of symbols displayed on a display screen, unlocking of special symbols of a higher RTP, an opportunity to participate in special events, and/or unlock new game features, and so on.

In some embodiments, a special symbol may be displayed as visually distinguishable from a standard symbol. Further, a target symbol, which is one type of a special symbol, may be displayed as visually distinguishable from a trigger symbol, which is another type of a special symbol. In some embodiments, and by way of a non-limiting example, when a special symbol displayed, a user may be notified using a distinguishable audible and/or visual alert.

Reference will now be made in detail to representative embodiments/aspects illustrated in the accompanying drawings. The following description is not intended to limit the embodiments to one preferred embodiment. On the contrary, it is intended to cover alternatives, combinations, modifications, and equivalents as can be included within the spirit and scope of the described embodiments as defined by the appended claims.

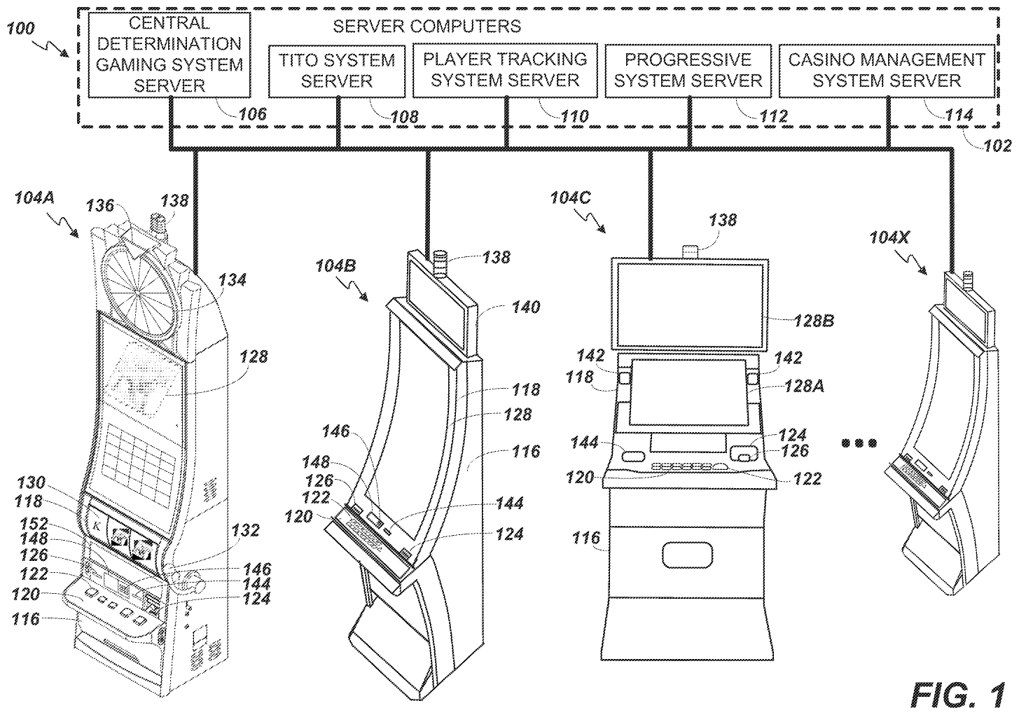

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

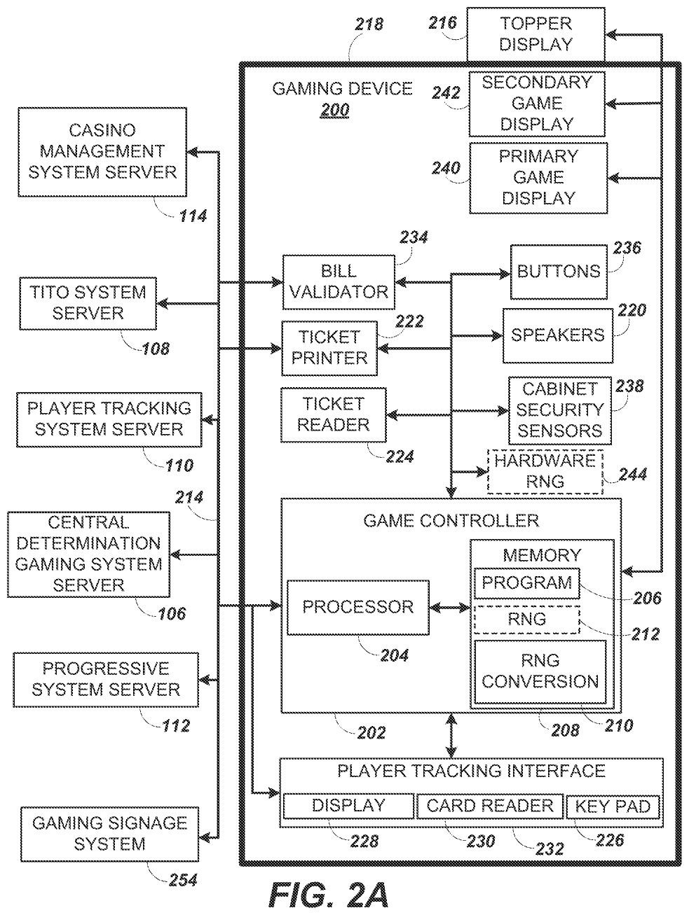

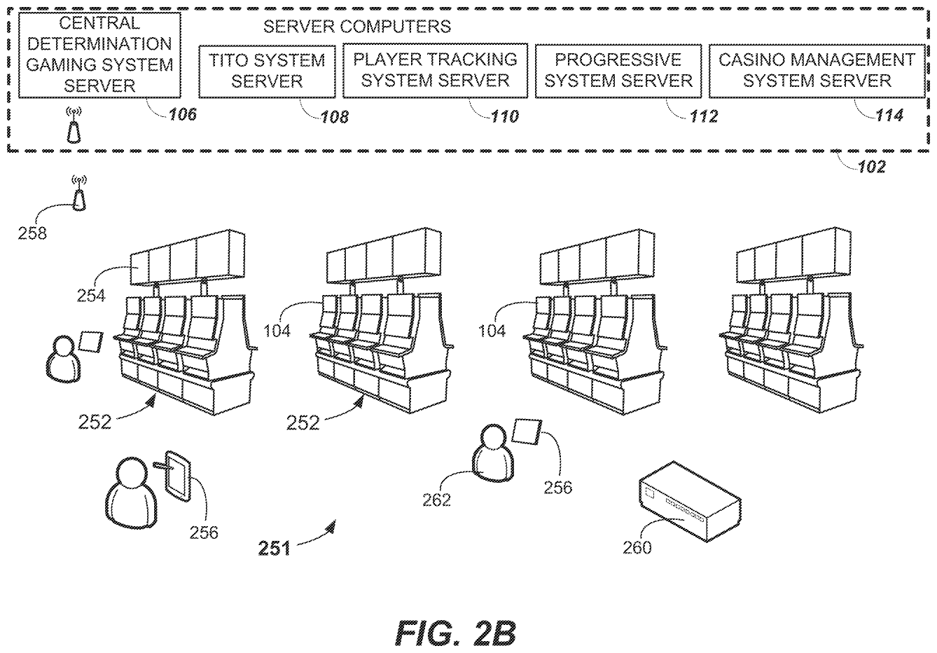

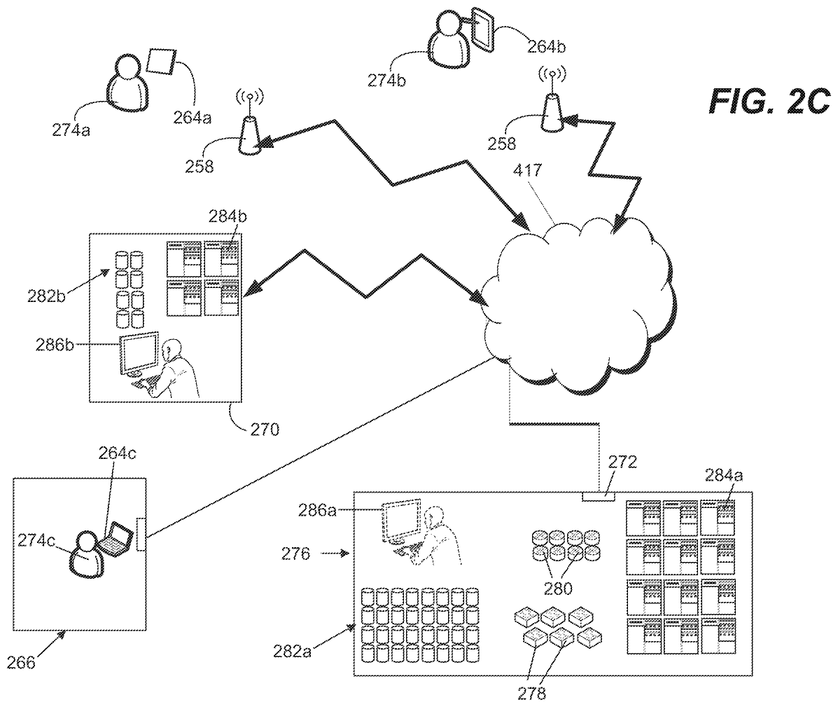

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may award players in a loyalty program. The player may use the player tracking interface 232 to access his/her account information, activate free play, and/or request various information. Player tracking or loyalty programs seek to award players for their play and help build brand loyalty to the gaming establishment. The awards typically correspond to the player's level of patronage (e.g., to the player's playing frequency and/or total amount of game plays at a given casino). Player tracking awards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

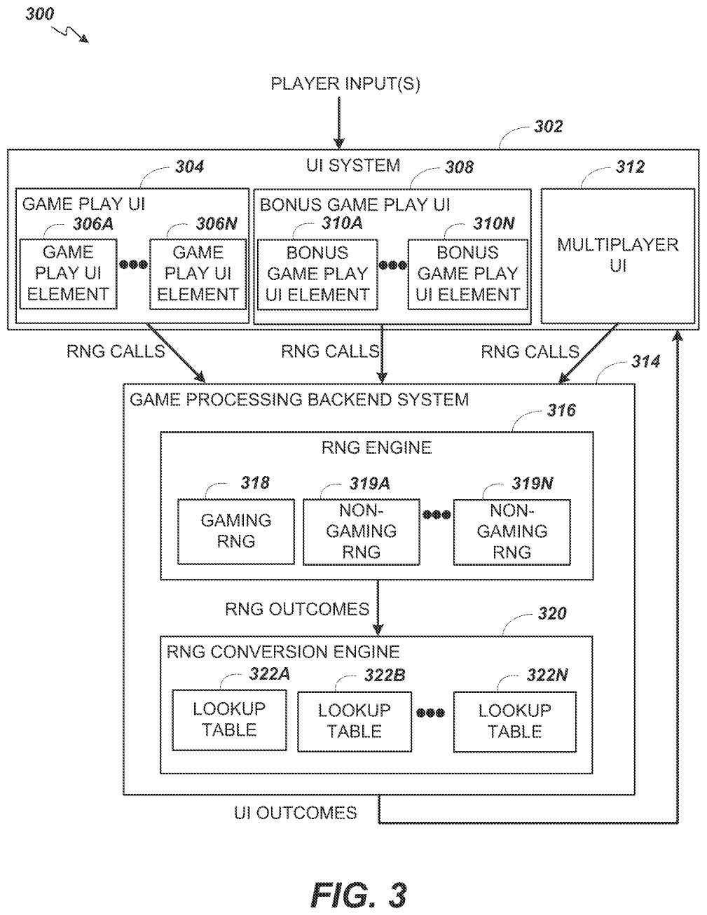

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (eg, GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

As discussed above, in contrast to conventional slot technology, embodiments of gaming devices described herein may generate and/or modify a game outcome, or part of a game outcome, based on symbols that spin by while the one or more reels are spinning. As a result, the gaming device may no longer wait and determine a game outcome by evaluating the symbols that land after the reels stop spinning. Such random game modifications when one or more reels are in the reel spin state, thus, present new game design challenges relating to controlling the degree of randomness at a target level within random gaming environments. Managing the degree of randomness becomes a compounding problem when the game device incorporates other game mechanics, such as landing re-spin symbols. Thus, the game device may include new and/or improved gaming process control functions to implement the winning-while-spinning game operation while complying with gaming regulations.

Various embodiments of a gaming device may implement one or more gaming process control functions to generate and/or modify the game outcome according to the winning-while-spinning game operation. In one embodiment, the gaming device implements a process control function that randomly determines the number of special symbols that will spin by for a given reel. If multiple reels will implement the winning-while-spinning game operation, the gaming device may perform separate RNG calls to determine the number of special symbols that will spin by for each reel. To create a relatively higher degree of randomness, the gaming device generates a dynamic reel strip that randomly determines the number of special symbols, reel positions for the special symbols, and/or reel length. By utilizing a dynamic reel strip, the reel strip layout will vary from game instance to game instance to avoid being predictive. During a given game instance, when the designated reels are spinning and special symbols spin by, the gaming device tracks and/or counts the accumulation of the special symbol type. For a given reel, once the number of special symbols that spin by reaches the designated number of special numbers, the reel stops.

In one or more embodiments, rather than directly determining the number of special symbols the game outcome will award, the gaming device may implement a gaming process control function that randomly determines the number of revolutions and/or partial revolutions to spin the entire length of a given reel strip. As an example, if the gaming device determines the number of revolutions to be two for a given reel, the reel will spin through its entire reel strip twice. The gaming device tracks and counts the number of special symbols that spin by during the two different revolutions. The number of revolutions the gaming device randomly determines may be weighted and controlled based on the number of special symbols in the given reel strip. The given reel strip can be a predetermined or known reel strip or can be a dynamic reel strip.

In one or more embodiments, for a game that utilizes mechanical reels or a secondary reel, the game may determine the number of steps to move the stepper or the time or frequency the reels step. For mechanical reels, symbols cannot be randomly generated. Thus, the special symbols are in specific reel positions and cannot be changed. By randomly determining the number of reel steps and/or time the reels step, the game can track and monitor the number of special symbols that spin by.

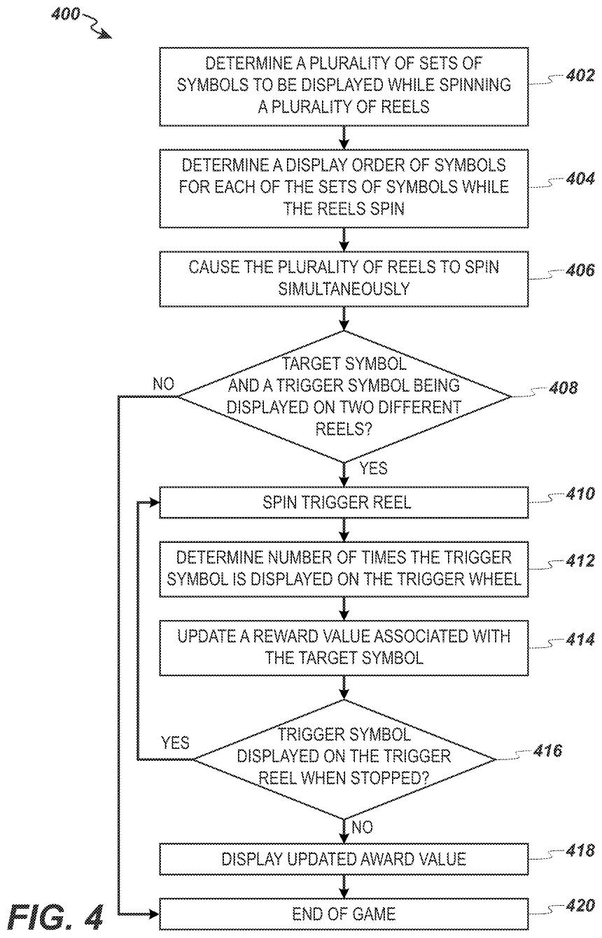

These and more embodiments are discussed in more detail below with respect to FIGS. 4-7B.

Various embodiments discussed herein may also address the issue of awards that may be made for various game outcomes. Roulette type games typically involve a wheel divided into 36 or a number of segments. In some versions, a ball is spun, and players are able to place bets as to which pocket adjacent to one of the segments the ball will fall into. Alternatively, in electronic versions, a stop position corresponding to one of the segments is randomly determined. Regardless, roulette type games may be required (such as by regulation, law, and so on) to maintain a particular RTP, such as 0.94. This means that, subject to the size of bets that are placed, the roulette type games may be very limited as to the awards that can be made for various game outcomes. Large awards (such as one or more jackpots) substantially out of proportion to the bets placed may be prohibited by RTP constraints due to the odds available. However, large awards substantially out of proportion to the bets placed provide more interest for players due to the chase involved, even when odds of winning are substantially lower.

To overcome this issue, a bonus game may be configured to be triggerable from a base game. The bonus game may involve selection of a winner between two opponents using a segmented wheel. Different jackpots and awards may be configured according to the odds of triggering the bonus game, selecting the opponents, selecting which of the opponents is the winner and which is the loser, selecting an order of the opponents (such as a home and away or visitor team), and so on. The highest jackpot may be configured for triggering the bonus game and selecting the opponents in their precise order, including the winner and loser, as this may correspond to the lowest compound odds of occurring.

In various implementations, a system may include a non-transitory storage medium that stores instructions and a processor. The processor may execute the instructions to determine a plurality of sets of symbols to be displayed during spinning of a plurality of reels. Each set of the plurality of sets of symbols may be associated with a respective reel of the plurality of reels. Each set of the plurality of sets of symbols may include a subset of symbols. The symbols may include one or more of: one or more standard symbols; one or more trigger symbols; or one or more target symbols. The processor may determine a respective display order of symbols for each set of the plurality of sets of symbols prior to the reels spinning (e.g., prior to the game being initiated). Generally, the playing field displayed on a display of the gaming device is a grid formed of rows and columns, each reel corresponding to a different column.

Typically, one of the reels is a trigger reel. Generally, although not necessarily, trigger symbols are displayed only on the trigger reel. Similarly, in some embodiments target symbols are displayed only on non-trigger reels but in other embodiments target symbols may also be displayed on the trigger reel.

In response to a user input, the processor may cause the plurality of reels to spin simultaneously. If the target symbol is displayed on a first reel and the trigger symbol is shown on the trigger reel, the processor may cause the trigger reel to re-spin. While the trigger reel is re-spinning, trigger symbols may be shown in the playing field as part of the trigger reel's spinning motion. If this occurs, the trigger symbols may be highlighted, divorced from the spinning motion of the trigger reel (for example, so that the player may register their display), moved at a different speed than the trigger reel, and so on. Further, the processor may update an award value associated with the target symbol(s) each time the trigger symbol displays on the reel. In this manner, a player's award may increase even while the trigger reel is in motion (e.g., spinning), permitting the player to accrue winnings or prizes even though the reel has not come to a stop

In some examples, at least one set of the plurality of sets of symbols may include a target symbol and at least one other set of symbols may include a trigger symbol. In some examples, a number of symbols in each set of the plurality of sets of symbols may be randomly determined. In other examples, a number of symbols in each set of the plurality of sets of symbols may be determined based on a reel length, and/or a duration of a reel to spin fully.

In certain embodiments the trigger reel may spin while the other reels remain stationary. For example, when a trigger is displayed on the reel once the reel stops spinning, the processor may cause the reel to re-spin. Before or during this re-spin the processor determines a second number of times the trigger symbol is or will be displayed on the reel. The processor may update the award value associated with the target symbol each time the trigger symbol is displayed on the trigger reel.

Further, the gaming device typically determines if any trigger symbol is displayed on the trigger reel when the reel stops its re-spin. If a trigger symbol is so displayed then the gaming device may re-initiate the special mode and spin the trigger reel another time, continuing to accumulate values, credits, bonuses, jackpot increments or the like each time a trigger symbol is displayed on the trigger wheel as generally described above. Otherwise, the special mode ends and the accumulated value (whether credits, bonus games, jackpot increments, values, additional reels or columns added to the playing field, or the like) is awarded to the player.

In some examples, a number of times each reel spins in response to the user input may be predetermined. In some implementations, the number of times each reel spins in response to the user input may be at least two, and/or at least one set of the plurality of sets of symbols may be updated before a new spin of each reel.

Another embodiment may utilize a wheel in addition to, or instead of, one of the reels of the playing field. For example, the wheel may substitute for a trigger reel. Thus, when a trigger symbol is selected or designated when the spinning wheel comes to rest, a special mode is initiated. The symbols on the wheel may be fixed or may vary with certain spins. Such embodiments generally operate similarly to those described above in other respects, including re-spinning of a wheel (or reels of the playing field) during the special mode, re-initiation of the special mode when a trigger symbol appears or is designated when the wheel stops re-spinning, and so on.

In some implementations, the reels may be caused to spin at different speeds, or at least one reel may spin at a different speed than other reels. The reels may be mechanical reels, and/or a respective speed of each reel of the plurality of reels may be determined based on a time period for spinning the plurality of reels.

FIG. 4 depicts a flow chart illustrating an example method 400 for operating dynamic reels of a game. The method 400 may be performed by one or more of the devices depicted in FIGS. 1-3. For example, certain operations of the method 400 may be performed by a processor, display, input mechanism, or the like of one or more of the devices depicted in FIGS. 1-3.

At operation 402, a processor of a gaming device (such as one or more of the devices depicted in FIGS. 1-3) may configure or determine a set of symbols for each reel of a plurality of reels. Portions of each set of symbols are displayed as the respective reels spin. A respective set of symbols for each reel of the plurality of reels may be dynamically and/or randomly determined using a RNG. Accordingly, each set of symbols may be a subset of symbols, and each set of symbols may be associated with a respective reel of the plurality of reels. In some embodiments, and by way of a non-limiting example, each set of symbols may be unique. In other words, each set of symbols may include at least one symbol that is not included in another set of symbols.

The symbol may be a standard symbol, a prize symbol, or a special symbol. The special symbol may be visually distinguishable from the standard symbol. By way of a non-limiting example, the special symbol may be of two different types—a target symbol or a trigger symbol. The target symbol may be visually distinguishable from the trigger symbol. Further, each target symbol and/or trigger symbol may have a corresponding distinguishable audible sound, which is played when the symbol is displayed on a reel. As described herein, each target symbol may have a corresponding cash or credit value, and/or a multiplier associated with it. The trigger symbol, as described herein, when displayed along with the target symbol, may trigger the game to enter into a special mode. If a target symbol is displayed without a trigger symbol, the game may not enter into the special mode. Similarly, if a trigger symbol is displayed without a target symbol, the game may not enter into the special mode.

In some embodiments, whether a symbol is a standard symbol or a special symbol is dynamically and/or randomly determined using a RNG. Accordingly, a symbol, for example, a letter “A,” may be designated as a standard symbol while a user is playing a game for the first time but may be designated as a special symbol while the user is playing the game for the second time, and/or when another user is playing the game.

By way of a non-limiting example, a dynamically and/or randomly determined set of symbols corresponding to each reel of the plurality of reels may include symbols that are: only standard symbols; only target symbols; only trigger symbols; a combination of standard symbols and target symbols; a combination of standard symbols and trigger symbols; a combination of target symbols and trigger symbols; or a combination of standard symbols, target symbols, and trigger symbols. Accordingly, each set of symbols may not include a trigger symbol. A set of symbols associated with a trigger reel only may include a trigger symbol. Prize symbols mentioned in the present disclosure may be considered to be standard symbols while determining each set of the plurality of sets of symbols.

In some embodiments, a total number of symbols in a set of symbols corresponding to a reel of the plurality of reels may be randomly determined by the processor of the gaming device using a RNG. In some implementations, the total number of symbols in the set of symbols may correspond with a total number of unique or non-unique symbols in the set of symbols displayed on a reel during one full revolution of the reel. In some embodiments, a total number of symbols in each set of symbols may be determined based on a reel length, and/or a duration of a reel to spin fully.

At operation 404, after a set of symbols for each reel of the plurality of reels is determined at operation 402, a respective order of symbols for each reel may be set or determined by the processor of the gaming device using a RNG. In other words, a particular order in which symbols may appear in the playing field during the game instance is determined using a RNG. In other words, a game outcome, for example, whether a special mode will be triggered during this game instance or not, is randomly determined using a RNG. Accordingly, which symbols are displayed on each reel in a playing field while reels are spinning is randomly set. Further, random selection of symbols and their respective order for each reel may make a prediction of an outcome of the game almost impossible or extremely difficult. A “playing field,” as described in the present disclosure, may refer to visible portions of a group of reels. A playing field may be an array of rows and columns, and each column (or row) may correspond to a respective reel. Each symbol displayed in the playing field of a reel thus occupies a separate row of a reel's column (or a separate column of a reel's row).

While operations 402 and 404 are described above with reference to an electronic gaming device, in some implementations operations 402 and 404 may be performed by randomly selecting each reel of the plurality of reels from a set of preconstructed reels. Each reel in the set of preconstructed reels may have symbols in a particular order. Accordingly, which symbols are displayed on each reel selected from a set of preconstructed reels in a playing field while reels are spinning is randomly set. Additionally, in some embodiments operations 402 and 404 may be reversed or executed simultaneously.

At operation 406, the plurality of reels may spin simultaneously as a game is initiated. The plurality of reels may be caused to spin in response to a user beginning the game using one or more tokens, tickets, credit(s), and/or cash, and so on. While the plurality of reels is spinning, the spinning reels may be monitored, as described herein as operation 408. In some embodiments, the plurality of reels may spin at the same speed. In some embodiments, one or more reels of the plurality of reels may spin at a different speed from other reels.

During operation 408, while reels are spinning, one or more target symbols and/or a trigger symbol may be displayed in a playing field corresponding to each reel. If a set of symbols for a reel includes one or more target symbols and/or a trigger symbol, the one or more target symbols and/or the trigger symbol may be displayed based on a respective order of symbols in the set of symbols. In some embodiments, and by way of a non-limiting example, a special mode may be initiated once one or more target symbols and a trigger symbol are displayed on at least two different reels while the plurality of reels stops spinning. In other embodiments, a special mode may be initiated when one or more target symbols and a trigger symbol are displayed on at least two different reels while the reels are still spinning. In certain embodiments, a special mode may be initiated when the one or more target symbols are displayed on at least one reel for a predetermined number of times, and a trigger symbol is displayed on at least one other reel for at least one time. In response to the target symbol and the trigger symbol both being displayed, operation 410, which corresponds with the special mode, is triggered. In some implementations, the special mode may be initiated when at least one target symbol and a trigger symbol are displayed on a single reel while the reel is spinning or when the reel stops.

During operation 410 a reel on which a trigger symbol was displayed may be caused to spin again. A reel on which the trigger symbol was displayed may be referred to herein as a “trigger reel.” In some embodiments, the trigger reel may be caused to spin for a randomly determined duration and/or for a randomly determined number of full or partial revolutions of the trigger reel. In some embodiments, the trigger reel may spin for a particular duration and/or particular number of revolutions based on a combination of the one or more target symbols and the trigger symbols displayed while the plurality of reels was spinning during operation 406.

During operation 412, each time the trigger symbol is displayed on the trigger reel during operation 410, an award value is incremented by a value corresponding to the one or more target symbols that initiated the re-spin of the trigger reel. This is reflected in operation 414, in which the award value is correspondingly increased. In some embodiments, the operation 414 may also include generating a distinguishable audio and/or visual notification to the user.

As the trigger reel stops spinning at operation 416, the processor of the gaming device may determine if a trigger symbol is displayed on the trigger reel. If a trigger symbol is not displayed on the trigger reel when it stops, then operation 418 is executed and the display of the gaming device shows an updated award value to the user. Following the operation 418, the game ends in operation 420.

Conversely, at operation 416, if the processor of the gaming device determines that a trigger symbol is displayed on the trigger reel when the trigger reel stops, the method may return to operation 410 and the trigger reel may spin again. Thus, as long as a trigger symbol is displayed on the trigger reel when the trigger reel stops spinning, the game continues. In some embodiments, the number of times the trigger reel may spin because of the trigger symbol landing on the trigger reel may be limited to a preconfigured number of times and/or in compliance with the gaming regulations.

In some embodiments, when the plurality of reels spins for more than one full revolution, a respective set of symbols corresponding to each reel may be dynamically and/or randomly updated or refreshed before each new revolution begins.

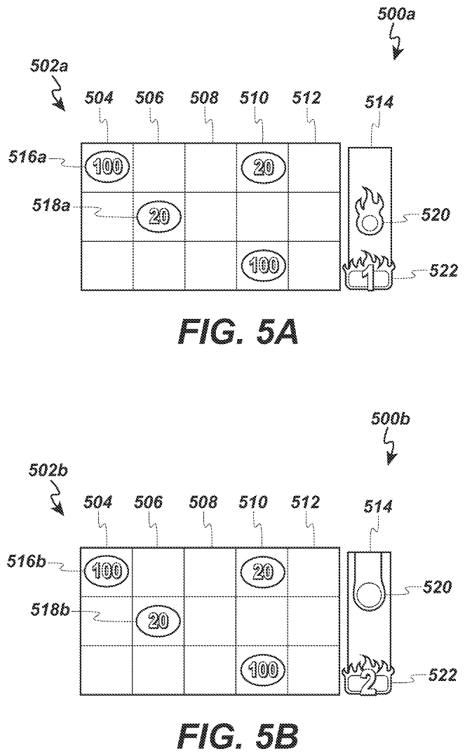

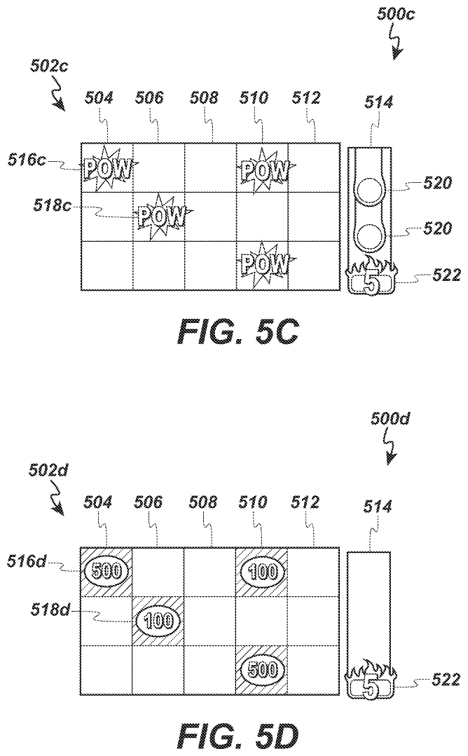

FIG. 5A depicts a first example screen view of a game implementing the method of FIG. 4. As shown in FIG. 5A, a playing field 502a of a gaming device may display a plurality of reels 504, 506, 508, 510, 512, and 514, which spin during the game as generally described with respect to operations 406 and 408 of FIG. 4. For each reel, a set of symbols to be displayed during spinning of the reel may be randomly and/or dynamically selected. As described herein, a set of symbols for each reel may be selected from symbols including standard symbols and special symbols. As stated earlier, special symbols may be further grouped into two different types of special symbols—target symbols and trigger symbols.

Target symbols can appear on any reel of the spinning reels 504, 506, 508, 510, 512, and/or 514. A trigger symbol can appear on a single reel or a predetermined number of reels of the spinning reels 504, 506, 508, 510, 512, and/or 514. The reel on which the trigger symbol appears, or the reel which displays the trigger symbol is then referenced as a trigger reel. In many implementations, where the trigger appears on a single reel, the single reel may be either the first reel or the last reel, for example, the reel 514 or the reel 504. However, any reel can be randomly selected to display a trigger symbol, and, therefore, selected as a trigger reel.

In the case when one or more target symbols are displayed on the one or more of the spinning reels 504, 506, 508, 510, 512, and 514 along with a trigger symbol on the one or more of the spinning reels 504, 506, 508, 510, 512, and 514, the game may enter into a special mode.

After a set of symbols for each reel is dynamically and/or randomly determined using a RNG, various symbols are displayed in a playing field corresponding to each reel as the reel spins. For example, symbols displayed on reels 504, 506, 508, 510, and 512 may include a “100” symbol 516a and a “20” symbol 518a. A “fireball” symbol 520 may be displayed on a reel 514. In the present case, symbols 516a and 518a both are special symbols of a target symbol type, and the fireball symbol 520 is a special symbol of a trigger symbol type. Since one or more target symbols and a trigger symbol are displayed on the reels 504, 510, 514, the game may enter into a special mode.

In some implementations, in the playing field 502a, a meter 522 may display how many trigger symbols are displayed on the trigger reel during a game or special mode. Further, since a trigger symbol 520 (e.g., the fireball symbol) appeared on the reel 514, the reel 514 may be considered a trigger reel. The trigger reel is here shown as physically separated from other reels. However, in some implementations, the trigger reel may not be physically separate from other reels.

As described herein, a set of symbols for the randomly selected one or more trigger reels may be selected from symbols including standard symbols, one or more target symbols, and/or one or more trigger symbols. However, since symbols for the set of symbols are randomly selected, it may occur that the set of symbols for a trigger reel may not include any trigger symbol. Accordingly, it is possible that, in certain game configurations, the special mode cannot be initiated. In such embodiments, the configuration of the trigger reel (e.g., the symbols and order of symbols making up the reel) may change from game to game, so that in certain games it is possible for the trigger symbol to appear on the reel and initiate the special mode while in others it is not possible for the trigger symbol to appear on the trigger reel. In yet other embodiments, the trigger reel 514 may always include at least one trigger symbol.

As shown on the playing field 502a, since one or more target symbol and a trigger symbol are displayed, the game may enter into the special mode during which the trigger reel is spun again.

FIG. 5B depicts a second example screen view of the game implementing the method of FIG. 4. In particular, FIG. 5B illustrates a playing field 502b while the game has entered into the special mode (e.g., while the trigger reel 514 is re-spinning) as generally described above with respect to operations 410-414. As the trigger reel 514 re-spins, the trigger symbol 520 may be displayed on the trigger reel again. If the trigger symbol is displayed on the trigger reel during the re-spin, the meter 522 may be updated or incremented to reflect the reappearance of the trigger symbol 520. In this example the trigger symbol is displayed on the trigger reel 514 twice and so a credit value associated with each target symbol displayed on the reels 504, 506, 508, 510, 512 is doubled from its initial value (since the trigger symbol has appeared twice). Similarly, if the trigger symbol occurs three times during the trigger reel's re-spin, the credit values may be tripled, and so on. Additionally, and as shown in FIG. 5B, updated credit values 516b, 518b corresponding to each target symbol may be displayed.

FIG. 5C illustrates a playing field 502c while the trigger reel 514 is still spinning during the special mode. While the trigger reel 514 is spinning, the trigger symbol 520 may be displayed on the trigger reel 514 again (as generally discussed above with respect to operations 410, 412, and/or 414 of FIG. 4). As the trigger symbol is displayed on the trigger reel again, the meter 522 may be updated as shown in the playing field 502c. As shown in the meter 522, since the trigger symbol has been displayed on the trigger reel five times, a credit value associated with each target symbol displayed on the reels 504, 506, 508, 510, and/or 512 may be updated to a new value from its initial value. As described herein, when the credit value corresponding to the target symbol has been updated or multiplied by a particular number of times, for example, five times, the target symbols may be shown as visually distinguishable, as shown in the playing field 502c as 516c, 518c, to draw the user's attention. In some implementations, when a trigger symbol occurs on the trigger reel, the special symbols may flash, expand, explode, or otherwise signal a change in their value. As another option, the special symbols may be momentarily replaced by another graphic (an explosion, burst, star, and so on) to signal the increment in value caused by the trigger symbol occurring on the trigger reel. Sample symbols 516c, 518c are shown in FIG. 5C. The replacement symbol may be noticeably registered to the player, and the player may note that his or her award value has increased, for example by five times in the special mode screen shown in FIG. 5C. In some implementations, visually distinguishable display of the target symbols may also be accompanied with an audible notification.

FIG. 5D depicts a fourth example screen view of the game described herein using FIG. 4. In particular, FIG. 5D illustrates a playing field 502d once the trigger reel 514 stops spinning at the end of the special mode. As the trigger reel 514 stops spinning without any trigger symbol 520 displayed on the trigger reel 514, the game stops as discussed above with respect to operations 418 and/or 420. A final updated award value corresponding to each target symbol may be displayed as 516d, 518d, as discussed above with respect to operation 418 and/or 420. This screen generally corresponds to operations 416 and 418.

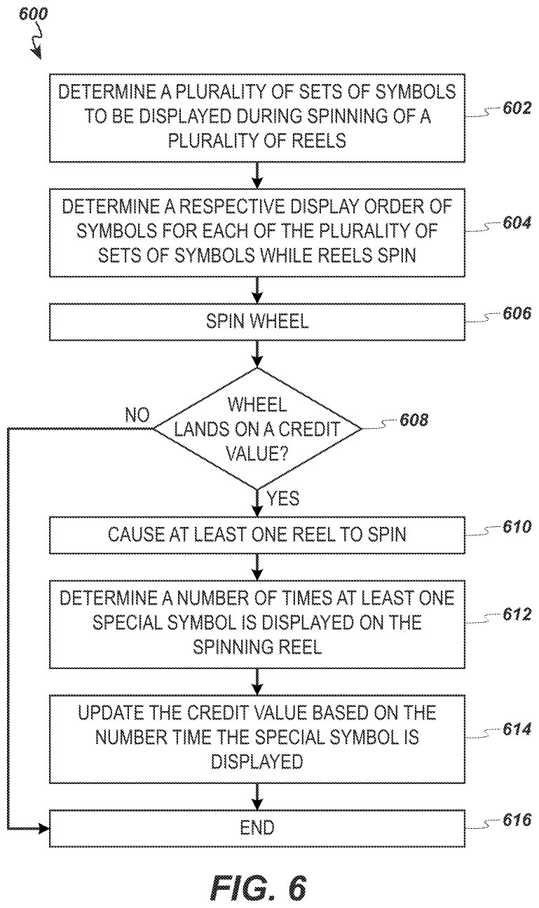

By way of illustration, FIG. 6 depicts a flow chart illustrating an example method 600 for operating a gaming device including dynamic reels and a spinning wheel. In comparison with an example method 400 described using FIG. 4, in this example method 600, a game may enter into a special mode based on a credit value to a user when a spinning wheel stops spinning. The method 600 may be performed by one or more of the devices depicted in FIGS. 1-3. In particular, the method 600 may be performed by a processor of one or more of the devices depicted in FIGS. 1-3.

At operation 602, a processor of a gaming device (such as one or more of the devices depicted in FIGS. 1-3) may configure or determine a set of symbols corresponding to each reel of a plurality of reels. Symbols from the set of symbols are displayed as the reel spins. A respective set of symbols for each reel of the plurality of reels may be dynamically and/or randomly determined using a RNG. Accordingly, each set of symbols may be a subset of symbols, and each set of symbols may be associated with a respective reel of the plurality of reels. In some embodiments, and by way of a non-limiting example, each set of symbols may be unique. In other words, each set of symbols may include at least one symbol that is not included in another set of symbols.

A symbol as described herein may include a letter, a number, a series of letters and/or numbers, and/or an image, and so on. The symbol may be a standard symbol, a prize symbol, or a special symbol. The special symbol may be visually distinguishable from the standard symbol. By way of a non-limiting example, the special symbol may be of two different types—a target symbol and a trigger symbol. The target symbol may be visually distinguishable from the trigger symbol. Further, each target symbol and/or the trigger symbol may have a corresponding distinguishable audible sound, which is played when the symbol is displayed on a reel. As described herein, each target symbol may have a corresponding cash or credit value, and/or a multiplier associated with it. The trigger symbol, as described herein, when displayed along with the target symbol, may trigger the game to enter into a special mode. If a target symbol is displayed without a trigger symbol, the game may not enter into the special mode. Similarly, if a trigger symbol is displayed without a target symbol, the game may not enter into the special mode.

In some embodiments, whether a symbol is a standard symbol or a special symbol is dynamically and/or randomly determined using a RNG. Accordingly, a symbol, for example, a letter “A,” may be designated as a standard symbol while a user is playing a game for the first time but may be designated as a special symbol while the user is playing the game for the second time, and/or when another user is playing the game.

By way of a non-limiting example, a dynamically and/or randomly determined set of symbols corresponding to each reel of the plurality of reels may include symbols that are: only standard symbols; only target symbols; only trigger symbols; a combination of standard symbols and target symbols; a combination of standard symbols and trigger symbols; a combination of target symbols and trigger symbols; or a combination of standard symbols, target symbols, and trigger symbols. Accordingly, each set of symbols may not include a trigger symbol. A set of symbols associated with a trigger reel only may include a trigger symbol. Prize symbols mentioned in the present disclosure may be considered to be standard symbols while determining each set of the plurality of sets of symbols.

In some embodiments, a total number of symbols in a set of symbols corresponding to a reel of the plurality of reels may be randomly determined by the processor of the gaming device using a RNG. In some implementations, the total number of symbols in the set of symbols may correspond with a total number of unique or non-unique symbols in the set of symbols displayed on a reel during one full revolution of the reel. In some embodiments, a total number of symbols in each set of symbols may be determined based on a reel length, and/or a duration of a reel to spin fully.

At operation 604, after a set of symbols for each reel of the plurality of reels is determined at operation 602, a respective order of symbols for each reel may be set or determined by the processor of the gaming device using a RNG. In other words, a particular order in which symbols may appear in the playing field during the game instance is determined using a RNG, and a game outcome, for example, whether a special mode will be triggered during this game instance or not, is randomly determined using a RNG. Accordingly, which symbols are displayed on each reel in a playing field while reels are spinning is randomly set. Further, random selection of symbols and their respective order for each reel may make a prediction of an outcome of the game almost impossible or extremely difficult.

While operations 602 and 604 are described above with reference to an electronic gaming device, in some implementations operations 602 and 604 may be performed by randomly selecting each reel of the plurality of reels from a set of preconstructed reels. Each reel in the set of preconstructed reels may have symbols in a particular order. Accordingly, which symbols are displayed on each reel selected from a set of preconstructed reels in a playing field while reels are spinning is randomly set.

At operation 606, a wheel of the electronic device may spin as a game is initiated. The spinning wheel may be caused to spin in response to a user beginning the game using one or more tokens, tickets, credit(s), and/or cash, and so on. In operation 608, as the spinning wheel stops, the processor of the gaming device may determine whether the wheel stops on a trigger symbol (such as a credit value, multiplier, special mode indicator, or the like). If so, then operation 610 is executed and the game enters into a special mode. Otherwise, the game stops in an end state operation 616.

During operation 610, which corresponds with the special mode, at least one reel of the plurality of reels may spin according to a predetermined criterion. In some embodiments, the predetermined criterion may include a number of reels to spin, a reel length and a reel speed corresponding to each reel of the number of reels selected to spin, and/or a duration for spinning of the at least one reel during the special mode. In some embodiments, during the operation 610, as a special symbol lands on a spinning reel, a distinguishable audio and/or visual notification to the user may be generated.

During operation 612, one or more special symbols may be displayed in a playing field of the at least one spinning reel. Based on a number of times the one or more special symbols is displayed on the at least one spinning reel during operation 614, an award value may be updated or incremented and displayed to the user. Following execution of operation 614, the game stops at operation 616.

In some embodiments, when the plurality of reels spin for more than one full revolution, a respective set of symbols corresponding to each reel may be dynamically and/or randomly updated or refreshed before each new revolution begins.

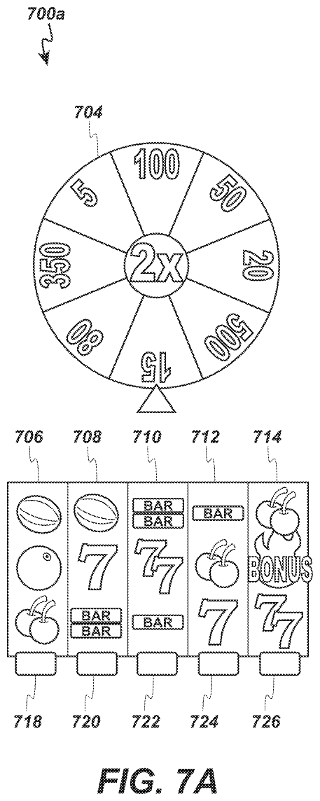

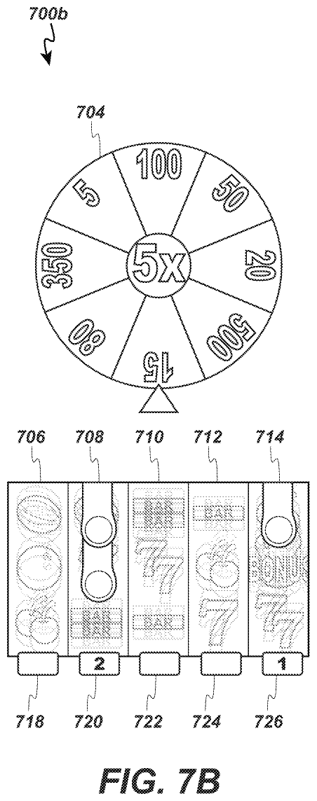

FIG. 7A depicts a first example screen view of a game described using FIG. 6. In a diagram 700a, a playing field of a gaming device during operation 606 is shown. As shown in the playing field, a game may include a spinning wheel 704 and a plurality of reels 706, 708, 710, 712, and 714. For each reel, a set of symbols to be displayed during spinning of the reel may be randomly and/or dynamically selected. A set of symbols for each reel may be selected from symbols including standard symbols and special symbols. One or more special symbols when displayed on the spinning reels 706, 708, 710, 712, and/or 714, while the reels 706, 708, 710, 712, and/or 714 are spinning, a credit value displayed on the spinning wheel 704 at the stop of the spinning wheel may be updated based on a number of times the one or more special symbols are displayed on any of the spinning reels 706, 708, 710, 712, and/or 714. In this example, the wheel 704 stops spinning before the plurality of reels 706, 708, 710, 712, and 714 spins. While the wheel 704 is spinning, the plurality of reels 706, 708, 710, 712, and 714 does not spin.

As shown in the playing field, as the wheel 704 spins and lands on a credit value to a user when the wheel stops spinning, the game may enter into a special mode, as described herein, in accordance with some embodiments. During the special mode, at least one reel of the plurality of reels 706, 708, 710, 712, and/or 714 may spin. In the present example, each reel of the plurality of reels 706, 708, 710, 712, and 714 spins during the special mode, as shown using FIG. 7B.

FIG. 7B depicts a second example screen view of a game described using FIG. 6. In a diagram 700b, a playing field may correspond with operation 608 and/or operation 610, in which the plurality of reels 706, 708, 710, 712, and 714 spin during the special mode. During the special mode, a special symbol, such as a fireball may be displayed on a spinning reel. A number of times one or more special symbols are displayed on each spinning reel may be displayed in a meter associated with each reel, for example, meters 718, 720, 722, 724, and 726. As shown in the playing field, the special symbol is displayed on the reel 708 two times and on the reel 714 one time, as shown in meters 720 and 726, respectively. Further, as shown in the playing field, since the total number of times the special symbol displayed on the spinning reels 706, 708, 710, 712, and 714 is three, the credit value to the user is updated to increase from 2× to 5× (added 3× more based on three special symbols being displayed on the spinning reels).

In some embodiments, a number of reels to spin during the special mode may be randomly determined. Alternately, a number of reels to be re-spun during the special mode is determined based on a credit value to the user. In some embodiments, a number of revolutions for which a reel spins may be randomly determined. Before the beginning of each new revolution, a set of symbols and/or a respective order of the symbols for a reel selected for spinning may be dynamically and/or randomly updated. In some embodiments, a reel may be selected to spin for a randomly determined reel length. In some embodiments, each reel selected for spinning may spin at different speeds.

In some embodiments, a gaming device may use an overlay or a secondary reel to display the special mode. The overlay may be a display screen or a new playing field that is displayed over the playing field shown during the standard game. Similarly, the secondary reel may be an additional reel and may not be used during other game modes.

In some embodiments, a gaming device may utilize mechanical reels, which may be controlled (e.g., rotated) by a stepper motor. The gaming device may determine a number of steps to move the stepper motor and thus a number of symbols to rotate through, and so be displayed on, the playing field. Additionally, or alternatively, the number of steps to move the stepper motor may be time-based and/or frequency-based. In embodiments using a stepper motor to control mechanical reels, symbols cannot be randomly generated. Accordingly, the special symbols located in specific reel positions cannot be dynamically changed. However, by randomly determining a number of reel steps and/or duration for the reels to step, the number of times special symbols are shown on the playing field may be randomized, and may be tracked and/or monitored (or, alternatively, predetermined in accordance with the random determination).

Although specific structures, methods, and implementations have been described above it should be appreciated that various embodiments may vary and/or all of the foregoing, or may add or remove functionality. As one example, in certain embodiments the target symbols may function as credit or wild multipliers instead of having set values. Alternatively, the target symbols may award additional spins of a base game or special mode or may award free games instead of adding to a player's award. In still other examples the target symbols may unlock additional rows, columns, or reels of a playing field, which in turn increases a player's RTP and/or volatility while such additional rows, columns, or reels are active. Still other embodiments may increase a height of one or more reels shown on the playing field when a target symbol appears or when a trigger symbol appears during the special mode. These examples of game functionality may occur when a target symbol appears on a playing field during a standard game, when the target symbols are present on the playing field and a trigger symbol appears on a trigger reel during a special mode, and so on.

In another example embodiment, all reels may re-spin during a special mode. Each time a trigger symbol appears on the trigger reel during the special mode, any target symbols shown on the playing field may be held at their displayed position throughout the duration of the special mode. This embodiment permits a player to accumulate special symbols in the playing field during the special mode, potentially increasing the payout (or other award) at the end of the special mode.

Still other embodiments may utilize special symbols and/or target symbols to extend play time of a game. This may be combined with a tournament mode of a gaming device to provide a player additional time to accrue credits, points, or the like and achieve a higher standing in the tournament.

Certain embodiments may utilize target symbols and/or trigger symbols to unlock game features, such as game windows, increased payout modes, changes to symbols on reels, and the like. These game features may be unlocked by accruing trigger symbol appearances on a trigger reel during a special mode, increasing target symbol values or changing target symbols shown on a playing field every time a trigger symbol appears on a trigger reel during a special mode, or otherwise tying the unlock to the special mode. In some other embodiments, special symbols may cause the game to enter into a special mode that is referenced herein as a hold and spin feature. During the hold and spin feature, the game designates one or more reels to spin. While the one or more designated reels are spinning, each time a special symbol appears on any of the one or more designated reels, a credit value associated with special symbols that triggered the hold and spin feature is upgraded or updated.

Although embodiments herein describe the use of a meter to track or otherwise visually display a number of times a trigger symbol appears on a trigger reel during a special mode, this is not necessary. Some embodiments may omit the meter, may substitute another visual or auditory indicator for the meter, or otherwise track the display of trigger symbols. As one non-limiting example, a trigger symbol may be constantly displayed on a display of the gaming device and may grow in size every time a corresponding trigger symbol appears on a trigger reel during a special mode. As another example, a color or brightness of a trigger symbol, target symbol, reel, game background, or the like may change each time a trigger symbol is displayed on a trigger reel during a special mode. Other visual or auditory indicators may be used instead of or in conjunction with the meter described herein.

FIGS. 5A-5D generally show the trigger reel being slightly separated from the other reels on the playing field. Other embodiments may omit this separation, increase this separation, display the trigger reel in a separate display or playing field from the other reels, display the trigger reel as larger or smaller than the other reels, or otherwise visually distinguish the trigger reel in some fashion. Further, in certain embodiments the trigger reel may be visually distinguished during normal play and in a special mode while other embodiments may visually distinguish the trigger reel only during the special mode.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A system, comprising:
a non-transitory storage medium that stores instructions; and
a processor that executes the instructions to:
for a game instance that includes reels, generate a dynamic reel strip using a random number generator call, the dynamic reel strip assigned to one of the reels and including special symbols;
during spinning of the reels, track an amount of the special symbols that spin by on the one of the reels;
once the amount of the special symbols reaches a designated number, stop the spinning of the reels; and
generate a game outcome.

2. The system of claim 1, wherein the processor uses the random number generator call to determine a number of the special symbols to include on the dynamic reel strip.

3. The system of claim 1, wherein the processor uses the random number generator call to determine reel positions for the special symbols on the dynamic reel strip.

4. The system of claim 1, wherein the processor uses the random number generator call to determine a reel length of the dynamic reel strip.

5. The system of claim 1, wherein the processor further executes the instructions to, in response to determining that a target symbol is displayed on a first reel of the reels and a trigger symbol is displayed on a second reel of the reels:
re-spin the second reel;
count a number of times the trigger symbol is displayed on the second reel; and
update an award value associated with the target symbol for the number of times that the trigger symbol is displayed on the second reel.

6. The system of claim 5, wherein:
the second reel is a trigger reel; and
the trigger symbol occurs only in the trigger reel.

7. The system of claim 1, wherein a number of times each reel spins is predetermined.

8. The system of claim 1, wherein the processor further executes the instructions to generate an additional dynamic reel strip, using an additional random number generator call, the additional dynamic reel strip assigned to a second of the reels and including at least a portion of the special symbols.

9. A system, comprising:
a non-transitory storage medium that stores instructions; and
a processor that executes the instructions to:
for a game instance that includes reels, use a random number generator call to determine a number of at least partial revolutions to spin a reel strip assigned to one of the reels;
during spinning of the reels, track an amount of special symbols that spin by on the one of the reels;
once the amount of the special symbols reaches a designated number, stop the spinning of the reels; and
generate a game outcome.

10. The system of claim 9, wherein the at least one processor further executes the instructions to spin an entirety of the reel strip for each of the number of at least partial revolutions.

11. The system of claim 9, wherein the at least partial revolutions are full revolutions.

12. The system of claim 9, wherein the number of at least partial revolutions are weighted and controlled based on a number of special symbols in the reel strip.

13. The system of claim 9, wherein the at least one processor further executes the instructions to dynamically generate the reel strip for the game instance.

14. The system of claim 9, wherein the at least one processor further executes the instructions to:
cause a display to show the reels initially spinning;
in response to a player input received by a user input device, cause the display to show the reels as stationary;
in the event a trigger reel of the reels displays a trigger symbol when stationary and at least another reel of the reels displays one of the special symbols when stationary:
cause the display to show the trigger reel as re-spinning;
for each time the trigger symbol is shown on the display as the trigger reel is re-spinning, increment an award; and
in response to displaying the trigger reel as stationary a second time, awarding the award.

15. The system of claim 14, wherein the one of the special symbols is a multiplier.

16. The system of claim 14, wherein the award is incremented while the trigger reel is re-spinning.

17. A system, comprising:
a non-transitory storage medium that stores instructions; and
a processor that executes the instructions to:
for a game instance that includes reels, use a random number generator call to determine a number of steps to move a stepper corresponding to one of the reels or a time or frequency that the one of the reels steps, the one of the reels including special symbols;
during spinning of the reels, track an amount of special symbols that spin by on the one of the reels;
once the amount of the special symbols reaches a designated number, stop the spinning of the reels; and
generate a game outcome.

18. The system of claim 17, wherein the one of the reels is a mechanical reel.

19. The system of claim 17, wherein the processor further executes the instructions to:
spin the reels at different speeds;
in response to a target symbol and a trigger symbol being displayed on two different reels of the reels, update an award value associated with the target symbol each time the trigger symbol is displayed.

20. The system of claim 19, wherein a respective speed of each reel of the reels is determined based on a duration for which the reels spin.
